(19) United States
(12) Patent Application Publication
(10) Pub. No.: US 2015/0077686 A1
(43) Pub. Date: Mar. 19, 2015

(54) SUBSTRATE FOR ELECTRO-OPTICAL DEVICE, ELECTRO-OPTICAL DEVICE, AND ELECTRONIC APPARATUS

(71) Applicant: Seiko Epson Corporation, Tokyo (JP)

(72) Inventor: Noboru Koyama, Suwa-shi (JP)

(21) Appl. No.: 14/477,024

(22) Filed: Sep. 4, 2014

(30) Foreign Application Priority Data
Sep. 13, 2013 (JP) 2013-190201

(51) Int. Cl. G02F 1/1335; G02F 1/1343

(52) U.S. Cl. CPC G02F 1/133514; G02F 1/13439; G02F 1/134309
USPC 349/106

(57) ABSTRACT

A substrate for an electro-optical device includes, on a base material, a third interlayer insulation layer, a plurality of first wirings with a light shielding property which are provided on the third interlayer insulation layer, a concave portion provided in the third interlayer insulation layer (second interlayer insulation layer) of a region interposed by adjacent first wirings of the plurality of first wirings in a plan view, a protective film provided so as to cover at least the plurality of first wirings, a color filter provided in the concave portion, a second oxide film provided on the color filters and the plurality of first wirings, and a pixel electrode provided on the second oxide film.

### BACKGROUND

1. Technical Field

The present invention relates to a substrate for an electro-optical device including a color filter, an electro-optical device, and an electronic apparatus.

2. Related Art

As the electro-optical device described above, for example, a liquid crystal device in an active drive method which includes a transistor as an element of performing a switching control on a pixel electrode for each pixel has been known. The liquid crystal device is used in, for example, a direct view display, a light bulb, or the like.

For example, in JP-A-2009-48063, a stack structure in which a color filter (coloring layer) is made in the same substrate (a substrate for an electro-optical device or an element substrate) in which a pixel electrode or a switching element is made, a so-called on-chip color filter structure (COA structure), is disclosed.

According to the structure, since the color filter, the pixel electrode, or the like is made in the same substrate, it is possible to suppress a deviation between a pixel region and a color filter region (a set deviation is caused) such as when separately making the element substrate and the color filter substrate.

However, in an on-chip color filter structure, if there is a gap between a color filter and a wiring (source line, capacity line or the like) adjacent to a color filter region, light leakage occurs from the gap in some cases. Accordingly, there is a problem that a display quality is lowered due to color mixture and the like caused by a difference in a refractive index of the color filter region and the like.

### SUMMARY

The invention can be realized in the following forms or application examples.

### APPLICATION EXAMPLE 1

According to this application example, there is provided a substrate for an electro-optical device, including, a base, a first insulation layer provided above the base, the first insulation layer has a concave portion, a plurality of first wirings provided above the first insulation layer so as to interpose the concave portion, a protective film provided so as to cover the plurality of the first wirings, a color filter provided in the concave portion, a second insulation layer provided above the color filter and the plurality of first wirings, and a pixel electrode provided above the second insulation layer.

In this case, since the first wirings with a light shielding property are provided so as to interpose a color filter in a plan view, for example, light passing through a pixel can be prevented from being incident on a color filter of an adjacent pixel. Accordingly, color mixture or light leakage can be prevented, thereby improving a display quality. In addition, since a protective film is provided between the first wiring and the color filter, the first wirings can be prevented from being corroded by contact between the first wirings and the color filters.

### APPLICATION EXAMPLE 2

In the substrate for an electro-optical device according to the application example, it is preferable that each of the plurality of first wirings not be electrically connected to wirings.

In this case, since the first wirings enter a floating state, for example, even if the protective film is not reliably formed in the first wirings, a metallic material included in the color filter can be suppressed so as not to affect a function of the first wirings as a wiring.

### APPLICATION EXAMPLE 3

In the substrate for an electro-optical device according to the application example, it is preferable that the protective film be provided over an inner surface of the concave portion from one of the plurality of the first wirings.

In this case, since the protective film is provided over the inner surface of the concave portion from the first wiring, the first wiring and the color filter can be reliably separated from each other and it is possible to prevent the first wiring from being corroded.

### APPLICATION EXAMPLE 4

According to this application example, there is provided an electro-optical device, including the substrate for an electro-optical device described above, an opposite substrate disposed to face the substrate for an electro-optical device, and an electro-optical layer disposed between the substrate for an electro-optical device and the opposite substrate.

In this case, since the electro-optical device includes the substrate for an electro-optical device, light incident through the electro-optical layer can be prevented from being color-mixed or from leaking, thereby improving a display quality.

### APPLICATION EXAMPLE 5

According to this application example, there is provided an electronic apparatus, including the electro-optical device described above.

In this case, since the electronic apparatus includes the electro-optical device described above, it is possible to provide an electronic apparatus which can improve a display quality.

### BRIEF DESCRIPTION OF THE DRAWINGS

The invention will be described with reference to the accompanying drawings, wherein like numbers reference like elements.

FIG. 1 is a schematic plan view which shows a configuration of a liquid crystal device.

FIG. 2 is a schematic cross-sectional view taken along line II-II of the liquid crystal device shown in FIG. 1.

FIG. 3 is an equivalent circuit diagram which shows an electrical configuration of the liquid crystal device.

FIG. 4 is a schematic cross-sectional view which mainly shows a structure of a pixel of a liquid crystal device.

FIG. 5 is a schematic plan view which shows in detail a structure of an element substrate as a substrate for an electro-optical device.

FIGS. 6A and 6B are schematic cross-sectional views taken along line A-A′ and line B-B′ of the element substrate shown in FIG. 5.

FIG. 7 is a flowchart which shows a method of manufacturing a liquid crystal device in a process order.

FIGS. 8A to 8C are schematic cross-sectional views which show a portion of the method of manufacturing a liquid crystal device.

FIGS. 9A to 9C are schematic cross-sectional views which show a portion of the method of manufacturing a liquid crystal device.

FIGS. 10A to 10C are schematic cross-sectional views which show a portion of the method of manufacturing a liquid crystal device.

FIG. 11 is a schematic diagram which shows a configuration of a projection type display device including the liquid crystal device.

### DESCRIPTION OF EXEMPLARY EMBODIMENTS

Hereinafter, embodiments which embody the invention will be described referring to drawings. Drawings to be used are displayed to be appropriately enlarged or reduced so that a portion to be described becomes recognizable.

For example, “on a substrate” described in following embodiments indicates a case of being disposed to be in contact with a substrate, a case of being disposed through another structure on a substrate, or a case of partially being disposed so as to be in contact on a substrate and of partially being disposed through another structure.

In the embodiment, as an example of the electro-optical device, an active matrix type liquid crystal device which includes a thin film transistor (TFT) as a switching element of a pixel is described as an example. The liquid crystal device can be appropriately used as, for example, a light modulation element (liquid crystal light valve) of a projection type display device (liquid crystal projector). Configuration of Liquid Crystal Device as Electro-optical Device

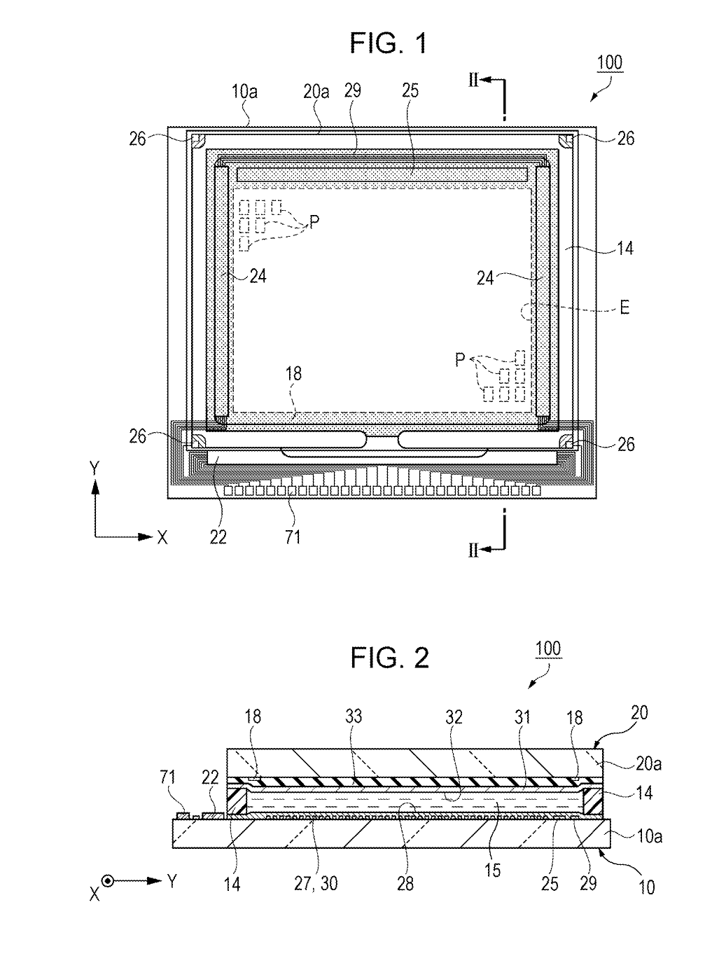

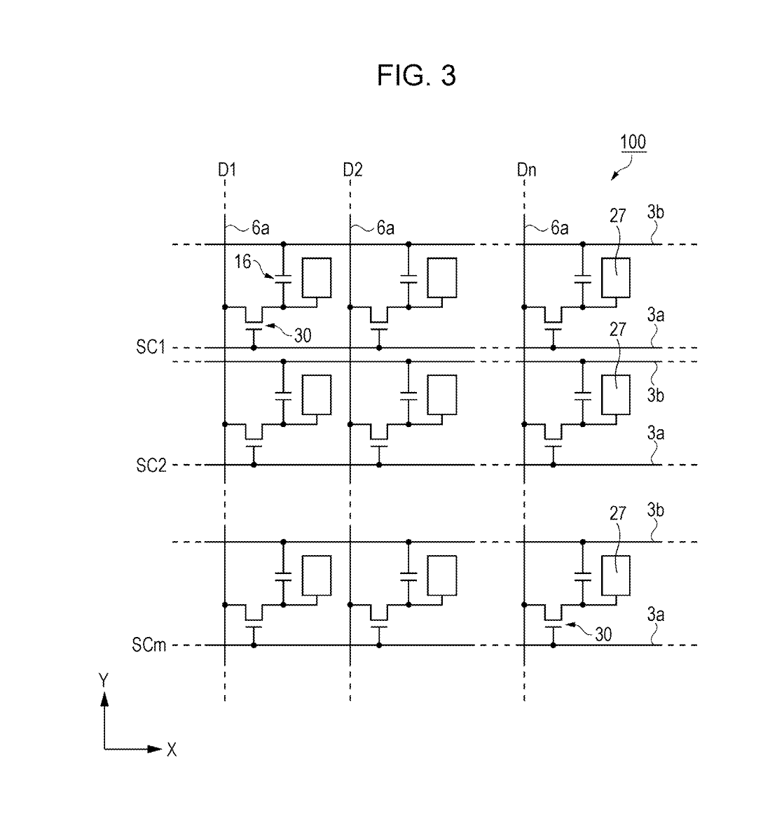

FIG. 1 is a schematic plan view which shows a configuration of a liquid crystal device. FIG. 2 is a schematic cross-sectional view taken along line II-II of the liquid crystal device shown in FIG. 1. FIG. 3 is an equivalent circuit diagram which shows an electrical configuration of the liquid crystal device. Hereinafter, a configuration of the liquid crystal device will be described referring to FIGS. 1 to 3.

As shown in FIGS. 1 and 2, a liquid crystal device 100 of the embodiment includes an element substrate 10 and an opposite substrate 20 which are disposed to face each other, and a liquid crystal layer 15 as an electro-optical layer which is interposed by a pair of these substrates. A transparent substrate such as a glass substrate or a quartz substrate is used for a base material 10a configuring the element substrate 10 and a base material 20a configuring the opposite substrate 20.

The element substrate 10 is larger than the opposite substrate 20, and both substrates are bonded via a sealing material 14 disposed along an outer periphery of the opposite substrate 20. A liquid crystal which has a positive or a negative dielectric anisotropy is enclosed in the gap to configure the liquid crystal layer 15.

As the sealing material 14, an adhesive such as thermosetting or UV-curable epoxy resin and the like is adopted. Spacers (glass beads) for constantly maintaining a gap between a pair of the substrates are mixed in the sealing material 14. The glass beads are used to maintain a cell gap.

Inside the sealing material 14, a display region E in which a plurality of pixels P contributing to a display are arranged is provided. A dummy pixel region (not shown) which does not contribute to a display is provided in a periphery of the display region E. Moreover, although not illustrated in FIGS. 1 and 2, a light-shielding portion (black matrix: BM) which respectively partitions a plurality of pixels P in a planar manner in the display region E is provided in the opposite substrate 20.

A data line driving circuit 22 is provided between the sealing material 14 along one side of the element substrate 10 and the one side. In addition, an inspection circuit 25 is provided between the sealing material 14 along the other side facing the one side and the display region E. Furthermore, a scanning line driving circuit 24 is provided between the sealing material 14 along the other two sides which are orthogonal to the one side and face each other and the display region E. A plurality of wirings 29 which connect two scanning line driving circuits 24 are provided between the sealing material 14 along the other side which faces the one side and the inspection circuit 25.

Inside the sealing material 14 disposed in a frame shape at the opposite substrate 20 side, the light-shielding film 18 (side portion) in the same frame shape is provided. The light-shielding film 18 is made of, for example, a metal, a metal oxide, or the like with a light shielding property, and configures a display region E having a plurality of pixels P inside the light-shielding film 18. Although not illustrated in FIG. 1, the light-shielding film which partitions the plurality of pixels P in the display region E in a planar manner is provided.

A wiring leading to the data line driving circuit 22 and the scanning line driving circuit 24 is connected to a plurality of external connection terminals 71 arranged along the one side. Thereafter, description is provided by setting a direction along the one side to be an X direction, and setting a direction along other two sides which are orthogonal to the one side and face each other to be a Y direction.

As shown in FIG. 2, a light-permeable pixel electrode 27 and a thin film transistor (TFT: hereinafter, referred to as “TFT 30”) which is a switching element, that are provided for each pixel P, a signal wiring, and an alignment film 28 covering these are formed at a surface of the liquid crystal layer 15 side of the base material 10a.

In addition, a light-shielding structure which prevents a switching operation from being unstable by allowing light to be incident on a semiconductor layer in the TFT 30 is adopted. The element substrate 10 in the invention includes at least a pixel electrode 27, a TFT 30, a signal wiring, and an alignment film 28.

At a surface of the liquid crystal layer 15 side of the opposite substrate 20, the light-shielding film 18, an insulation layer 33 which is formed so as to cover the light-shielding film, an opposite electrode 31 which is provided so as to cover the insulation layer 33, and an alignment film 32 which covers the opposite electrode 31 are provided. The opposite substrate 20 in the invention includes at least the light-shielding film 18, the opposite electrode 31, and the alignment film 32.

As shown in FIG. 1, the light-shielding film 18 surrounds the display region E, and is provided at positions overlapping scanning line driving circuit 24 and an inspection circuit 25 in a plan view. Thus, by blocking light incident on a peripheral circuit including these driving circuits from the opposite substrate 20 side, the peripheral circuit is prevented from malfunctioning due to the light. Moreover, unnecessary stray light is blocked so as not to be incident on a display region E, and thereby a high contrast in a display of the display region E is ensured.

The insulation layer 33 is made of an inorganic material such as silicon oxide and the like, and has an optical transparency to be provided so as to cover the light-shielding film 18. As a method of forming such an insulation layer 33, methods of deposition such as a plasma Chemical Vapor Deposition (CVD) method and the like are exemplified.

The opposite electrode 31 which is made of a transparent conductive film such as Indium Tin Oxide (ITO) and the like covers the insulation layer 33, and is electrically connected to a wiring of the element substrate 10 side by a vertical conductor 26 provided at four corners of the opposite substrate 20 as shown in FIG. 1.

The alignment film 28 covering the pixel electrode 27 and the alignment film 32 covering the opposite electrode 31 are selected based on an optical design of the liquid crystal device 100. As the alignment films 28 and 32, an inorganic alignment film which is substantially vertically aligned with respect to a liquid crystal molecule having a negative dielectric anisotropy by depositing an inorganic material such as SiOx (silicon oxide) and the like using a vapor deposition method is exemplified.

The liquid crystal device 100 is, for example, a permeable type, and adopts an optical design of a normally white mode in which transmittance of a pixel P when a voltage is not applied is greater than transmittance when a voltage is applied, or a normally black mode in which transmittance of a pixel P when a voltage is not applied is less than transmittance when a voltage is applied. A polarizing element is disposed and used at an incident side and an emission side of light, respectively, according to the optical design.

As shown in FIG. 3, the liquid crystal device 100 includes at least a plurality of scanning lines 3a and a plurality of data lines 6a which are insulated and orthogonal to each other in the display region E, and a capacity line 3b. A direction in which the scanning line 3a extends is an X direction, and a direction in which the data line 6a extends is a Y direction.

The pixel electrode 27, the TFT 30, and the capacitor 16 are provided in a region partitioned by signal lines such as the scanning line 3a, the data line 6a, and the capacity line 3b, and these configure a pixel circuit of the pixel P.

The scanning line 3a is electrically connected to a gate of the TFT 30, and the data line 6a is electrically connected to a source/drain region at a data line side (source region) of the TFT 30. The pixel electrode 27 is electrically connected to a source/drain region at a pixel electrode side (drain region) of the TFT 30.

The data line 6a is connected to the data line driving circuit 22 (refer to FIG. 1) and supplies pixel signals D1, D2, . . . , Dn supplied from the data line driving circuit 22 to a pixel P. The scanning line 3a is connected to the scanning line driving circuit 24 (refer to FIG. 1), and supplies scanning signals SC1, SC2, . . . , SCm supplied from the scanning line driving circuit 24 to each pixel P.

The image signal D1 to Dn supplied from the data line driving circuit 22 to the data line 6a may be supplied line-sequentially in this order, and may be supplied to each group among a plurality of data lines 6a which are adjacent to each other. The scanning line driving circuit 24 line-sequentially supplies scanning signals SC1 to SCm to the scanning line 3a in a pulse manner at a predetermined timing.

The liquid crystal device 100 is made to have a configuration in which the TFT 30 that is a switching element is assumed to be in an on state only for a fixed period of time by an input of scanning signals SC1 to SCm, and thereby image signals D1 to Dn supplied from the data line 6a are written in the pixel electrode 27 at a predetermined timing. Then, the image signals D1 to Dn at a predetermined level written in the liquid crystal layer 15 through the pixel electrode 27 are maintained between the pixel electrode 27 and the opposite electrode 31 which is disposed to face the pixel electrode 27 through the liquid crystal layer 15 for a fixed period of time.

In order to prevent the maintained image signals D1 to Dn from leaking, the capacitor 16 is connected in parallel to a liquid crystal capacitor formed between the pixel electrode 27 and the opposite electrode 31. The capacitor 16 is provided between the source/drain region at a pixel electrode side of the TFT 30 and the capacity line 3b. The capacitor 16 has a dielectric layer between two capacitor electrodes.

### Configuration of Pixel Configuring Liquid Crystal Device

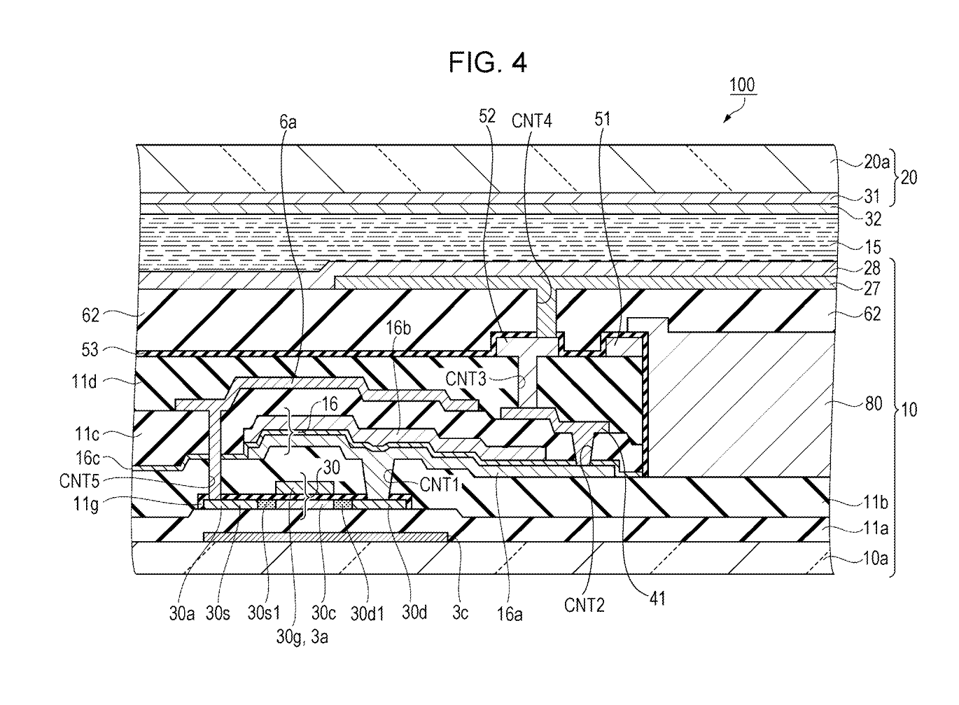

FIG. 4 is a schematic cross-sectional view which mainly shows a structure of a pixel of the liquid crystal device. Hereinafter, the structure of a pixel of the liquid crystal device will be described referring to FIG. 4. FIG. 4 shows a cross-sectional positional relationship of each configuration element, and is represented by an explicit scale.

As shown in FIG. 4, the liquid crystal device 100 includes the element substrate 10 as a substrate for an electro-optical device, and an opposite substrate 20 which is disposed to face the element substrate 10. A base material 10a configuring the element substrate 10, and a base material 20a configuring the opposite substrate 20 are configured to have, for example, a quartz substrate, and the like.

As shown in FIG. 4, a lower light-shielding film 3c including materials such as aluminum (Al), titanium (Ti), chromium (Cr), tungsten (W), and the like is formed on the base material 10a. The lower light-shielding film 3c is patterned in a lattice shape in a plan view, and stipulates an opening region of each pixel P. The lower light-shielding film 3c has conductivity and may be made to function as a portion of the scanning line 3a. An underlying insulation layer 11a made of silicon oxide and the like is formed on the base material 10a and the lower light-shielding film 3c.

The TFT 30, the scanning line 3a and the like are formed on the underlying insulation layer 11a. The TFT 30 has, for example, a Lightly Doped Drain (LDD) structure, and includes the semiconductor layer 30a made of poly-silicon (highly pure polycrystalline silicon) and the like, a gate insulation layer 11g formed on the semiconductor layer 30a, and a gate electrode 30g which is formed on the gate insulation layer 11g and is made of poly silicon film and the like. The scanning line 3a functions as the gate electrode 30g.

N-type impurity ions such as phosphorus (P) ions and the like are injected, and thereby the semiconductor layer 30a is formed as an N-type TFT 30. Specifically, the semiconductor layer 30a includes a channel region 30c, an LDD region at a data line side 30s1, a source/drain region at a data line side 30s, an LDD region at a pixel electrode side 30d1, and a source/drain region at a pixel electrode side 30d.

The channel region 30c is doped with p-type impurity ions such as boron (B) ions and the like. The other regions 30s1, 30s, 30d1, and 30d are doped with n-type impurity ions such as phosphorus (P) ions and the like. In this manner, the TFT 30 is formed as the N-type TFT.

A first interlayer insulation layer 11b made of silicon oxide and the like is formed on the gate electrode 30g and the gate insulation layer 11g. The capacitor 16 is provided on the first interlayer insulation layer 11b. Specifically, a first capacitor electrode 16a as a pixel potential capacitor electrode electrically connected to the source/drain region at a pixel electrode side 30d of the TFT 30 and the pixel electrode 27, and a portion of the second capacitor electrode 16b (capacity line 3b) as a fixed potential capacitor electrode are disposed to face each other via the dielectric film 16c, and thereby the capacitor 16 is formed.

The dielectric film 16c is, for example, a silicon nitride film. The second capacitor electrode 16b (capacity line 3b) is made of a single metal, an alloy, a metal silicide, a poly silicide, a stack of these, or the like which includes at least one of high melting point metals such as titanium (Ti), chromium (Cr), tungsten (W), tantalum (Ta), molybdenum (Mo), and the like. Alternatively, the second capacitor electrode 16b can be formed of an aluminum (Al) film.

The first capacitor electrode 16a is made of, for example, a conductive polysilicon film, and functions as a pixel potential capacitor electrode of the capacitor 16. However, the first capacitor electrode 16a, in the same manner as the capacity line 3b, may be configured from a single layer film or a multilayer film including a metal or an alloy. The first capacitor electrode 16a, in addition to a function as the pixel potential capacitor electrode, has a function of relay connecting of the pixel electrode 27 and the source/drain region at a pixel electrode side 30d (drain region) of the TFT 30 via contact holes CNT1, CNT2, CNT3, and CNT4.

The data line 6a is formed on the capacitor 16 via a second interlayer insulation layer 11c which is one of the first insulation layers. The data line 6a is electrically connected to the source/drain region at a data line side 30s (source region) of the semiconductor layer 30a via a contact hole CNT5 that is opened in the gate insulation layer 11g, the first interlayer insulation layer 11b, the dielectric film 16c, and the second interlayer insulation layer 11c.

A third interlayer insulation layer 11d which is one of the first insulation layers is provided on the data line 6a. The first wiring 51 and the second wiring 52 are provided on the third interlayer insulation layer 11d. A second oxide film 62 as a second insulation layer is provided on the first wiring 51, the second wiring 52, and the third interlayer insulation layer 11d via the protective film 53.

The pixel electrode 27 is provided on the second oxide film 62. The pixel electrode 27 is electrically connected to the second wiring 52 via a contact hole CNT4 formed on the second oxide film 62.

A color filter 80 is provided in the display region E in the second interlayer insulation layer 11c, the third interlayer insulation layer 11d, and a portion of the second oxide film 62. A structure of a periphery of the color filter 80 will be described below in detail. In addition, a planarization process such as Chemical Mechanical Polishing (CMP) and the like is performed on the third interlayer insulation layer 11d and a surface of the second oxide film 62.

The pixel electrode 27 is connected to a contact hole CNT1 via the contact hole CNT4, the second wiring 52, a contact hole CNT3, a replay layer 41, a contact hole CNT2, and a first capacitor electrode 16a. Accordingly, the pixel electrode 27 is electrically connected to the source/drain region at a pixel electrode side 30d (drain region) of the semiconductor layer 30a. The pixel electrode 27 is formed of a transparent conductive film such as an Indium Tin Oxide (ITO) film and the like.

The alignment film 28 on which inorganic materials such as silicon oxide (Si02) and the like are obliquely formed is provided on the pixel electrode 27 and the second oxide film 62. The liquid crystal layer 15 in which a liquid crystal and the like are enclosed in a space surrounded by the sealing material 14 (refer to FIGS. 1 and 2) is provided on the alignment film 28.

Meanwhile, an insulation layer (not shown) made of, for example, a PSG film (silicon oxide doped with phosphorus) and the like is provided on the base material 20a (liquid crystal layer 15 side). The opposite electrode 31 is provided across an entire surface on the insulation layer. The alignment film 32 on which inorganic materials such as silicon oxide (SiO₂) and the like are obliquely formed is provided on the opposite electrode 31. The opposite electrode 31 is made of a transparent conductive film such as an ITO film and the like in the same manner as the pixel electrode 27 described above.

The liquid crystal layer 15 takes a predetermined alignment state by the alignment films 28 and 32 with no electric field generated between the pixel electrode 27 and the opposite electrode 31. The sealing material 14 is an adhesive made of, for example, a light-curable resin or a thermosetting resin to bond the element substrate 10 and the opposite substrate 20, and a glass fiber or a spacer such as glass beads and the like for setting a distance between the element substrate 10 and the opposite substrate 20 to a predetermined value are mixed therein.

Structure of Element Substrate as Substrate for Electro-optical Device

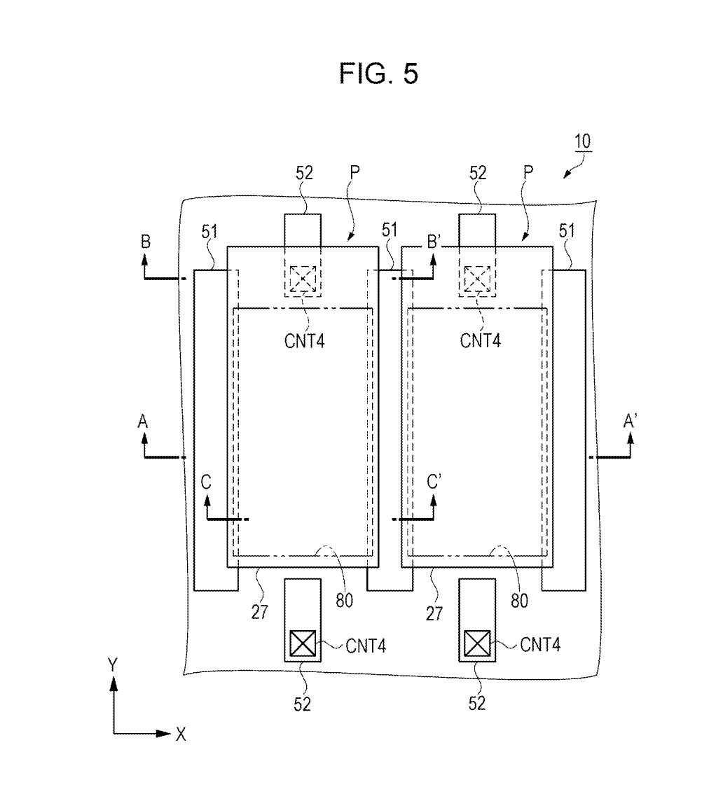

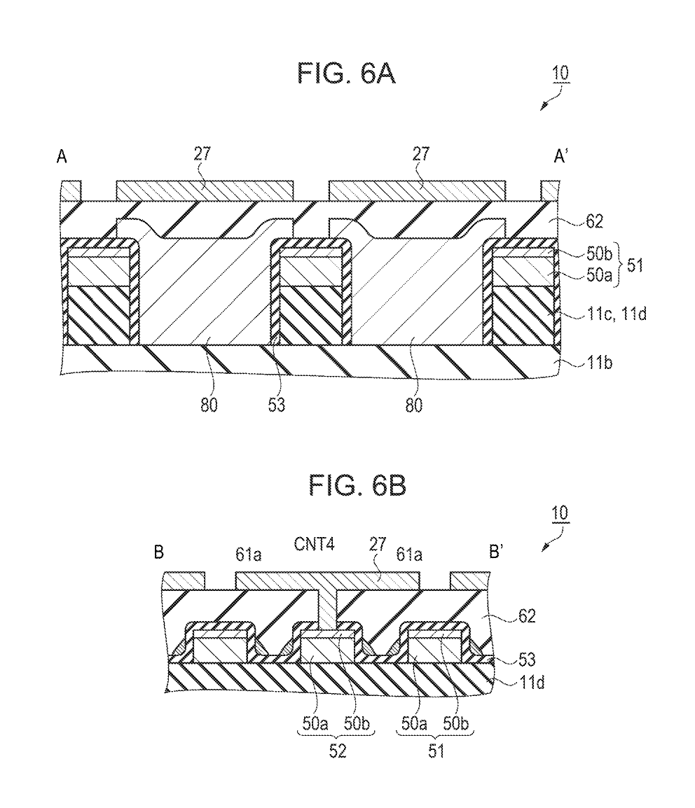

FIG. 5 is a schematic plan view which shows in detail a structure of an element substrate as a substrate for an electro-optical device in the liquid crystal device. FIGS. 6A and 6B are schematic cross-sectional views taken along line A-A′ and B-B′ of the element substrate shown in FIG. 5. Hereinafter, a structure of the element substrate will be described referring to FIGS. 5 to 6B.

As shown in FIG. 5, in the element substrate 10, the color filter 80, the first wiring 51 disposed between adjacent color filters 80 in an X direction, and the second wiring 52 disposed in a vicinity of the color filter 80 in a Y direction are provided in a region configuring a pixel P.

In addition, as shown in FIGS. 6A and 6B, the element substrate 10 has the first wiring 51 and the second wiring 52 provided on the base material 10a via the underlying insulation layer 11a to a third interlayer insulation layer 11d. As described above, the TFT 30 or the data line 6a, a capacitor 16, and the like are provided in the underlying insulation layer 11a to the third interlayer insulation layer 11d.

The first wiring 51 and the second wiring 52 are made to have a structure in which titanium nitride 50b is stacked on aluminum 50a. In the embodiment, the first wiring 51 is used as a light-shielding film for suppressing a color mixture of the adjacent color filters 80. Moreover, the first wiring 51 is not electrically connected to other wirings and the like, but is disposed in a floating state. The second wiring 52 is used as a relay electrode for electrically connecting the source/drain region at a pixel electrode side 30d and the pixel electrode 27.

The color filter 80, as shown in FIG. 6A, is provided in the second interlayer insulation layer 11c to the second oxide film 62 between the adjacent first wirings 51. The protective film 53 to prevent the first wiring 51 configured to include the aluminum 50a from being corroded by contact with the color filter 80 is provided between the color filters 80 and the first wirings 51. That is, the color filters 80 and the first wirings 51 are not in direct contact with each other.

The protective film 53 is, for example, a BSG film (silicon oxide containing boron). In addition, a portion of the color filter 80 is disposed to overlap a portion of the adjacent first wiring 51 in a plan view. The second oxide film 62 whose surface is planarized is provided on the color filter 80 and the first wiring 51.

The pixel electrode 27 is provided on the second oxide film 62 so as to overlap the color filter 80 in a plan view. The pixel electrode 27 is disposed to extend to a region overlapping a portion of the second wiring 52 in a plan view. The second wiring 52 is electrically connected to the pixel electrode 27 through a contact hole CN4, as shown in FIG. 6B.

In addition, on a side surface of the first wiring 51 (except for the first wiring 51 between the color filters 80) and the second wiring 52, a side wall 61a having an inclined surface is disposed through the protective film 53 described above, as shown in FIG. 6B. The side wall 61a is an oxide film. The oxide film is, for example, a low temperature CVD film (TEOS) processed by applying heat of about 150° C.

As described above, by forming the side wall 61a at a side surface of the second wiring 52, it is possible to moderate an angle of a concave and convex portion between the first wiring 51 and the second wiring 52. Therefore, when the second oxide film 62 is formed on the first wiring 51, the second wiring 52, and the third interlayer insulation layer 11d, it is possible to suppress a void (a gap where the second oxide film 62 is not filled) so as not to occur between the second wirings 52. Such a phenomenon is likely to occur when depositing a TEOS film in a structure having the color filter 80 in the element substrate 10.

A void is less likely to occur between the first wirings 51 in the color filter 80 region than between the second wirings 52.

### Method of Manufacturing Liquid Crystal Device Including Method of Manufacturing Substrate for Electro-Optical Device

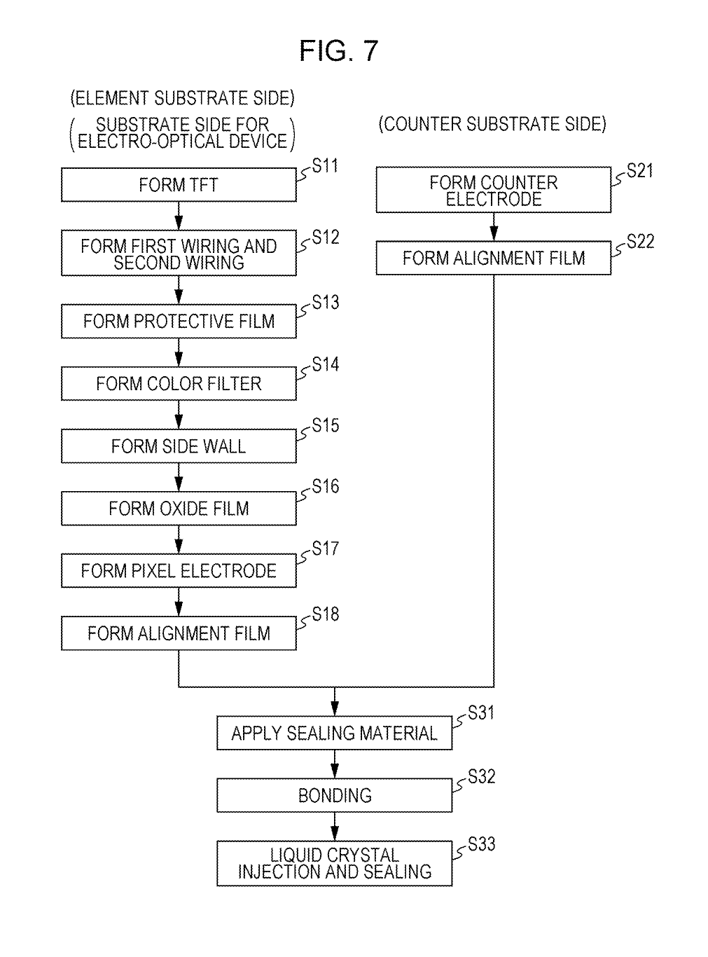

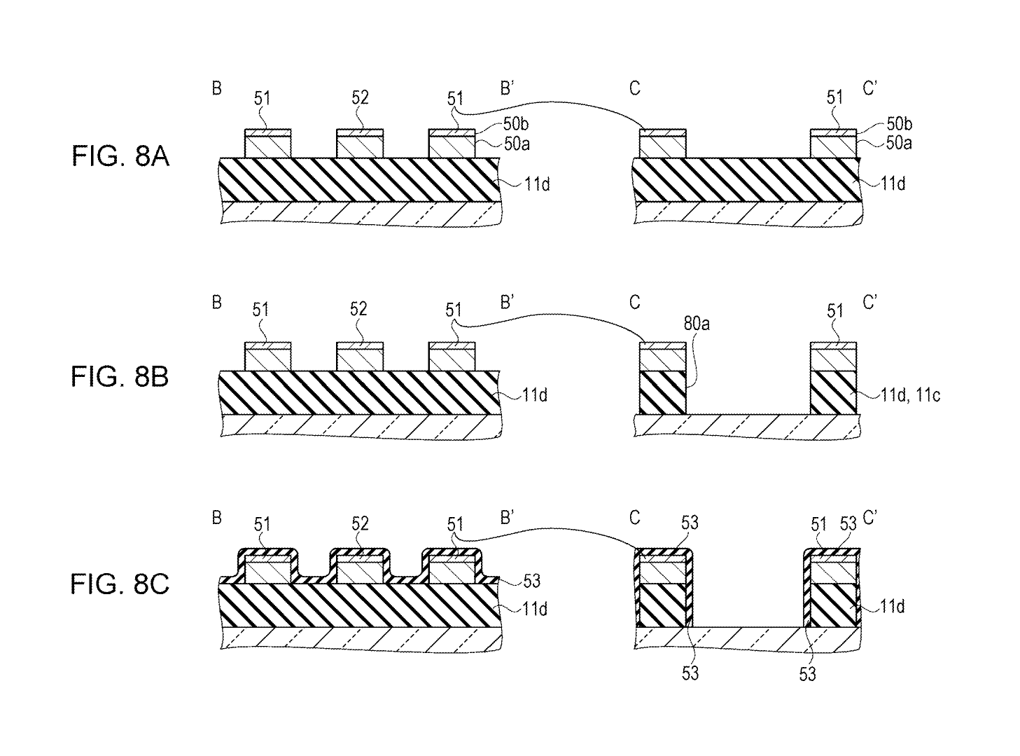

FIG. 7 is a flowchart which shows a method of manufacturing a liquid crystal device in a process order. FIGS. 8A to 10C are schematic cross-sectional views which show a method of manufacturing the first wiring and the second wiring of the element substrate among methods of manufacturing a liquid crystal device. Hereinafter, the methods of manufacturing a liquid crystal device will be described referring to FIGS. 7 to 10C.

At first, a method of manufacturing the element substrate 10 side will be described. First, in step S11, the TFT 30 is formed on the base material 10a which is made of a quartz substrate and the like. Specifically, first, the lower light-shielding film 3c (scanning line) which is made of the aluminum 50a and the like is formed on the base material 10a. Thereafter, by using a well-known deposition technique, the underlying insulation layer 11a which is made of a silicon oxide film and the like is formed.

Next, the TFT 30 is formed on the underlying insulation layer 11a. Specifically, the TFT 30 is formed using a well-known deposition technique such as a photolithographic technique and an etching technique.

In step S12, the first wiring 51 and the second wiring 52 are formed. In step S13, the protective film 53 is formed. In step S14, the color filter 80 is formed. In step S15, the side wall 61a is formed. In step S16, the second oxide film 62 is formed. In step S17, the pixel electrode 27 is formed. Hereinafter, detailed manufacturing methods in steps S12 to S17 will be described referring to FIGS. 8A to 10C.

First, in a process shown in FIG. 8A, the first wiring 51 and the second wiring 52 are formed on the third interlayer insulation layer 11d. Specifically, the first interlayer insulation layer 11b to the third interlayer insulation layer 11d which includes the TFT 30 and the like described above are formed. The capacitor 16, the data line 6a, the contact holes CNT1 to CNT4 and the like are not illustrated and a method of manufacturing these are omitted. Next, the aluminum (Al) 50a and titanium nitride (TiN) 50b are stacked on the third interlayer insulation layer 11d. Thereafter, the first wiring 51 and the second wiring 52 are patterned by using the photolithographic technique and the etching technique to be formed.

In a process shown in FIG. 8B, a concave portion 80a for forming the color filter 80 is formed. Specifically, the concave portion 80a is formed in the third interlayer insulation layer 11d (in detail, the second interlayer insulation layer 11c is also included) between adjacent first wirings 51 by using the photolithographic technique and the etching technique.

In a process shown in FIG. 8C, the first wiring 51, the second wiring 52, the concave portion 80a (inner surface of the concave portion 80a), and the protective film 53 on the third interlayer insulation layer 11d are formed. The protective film 53 is a BSG film as described above.

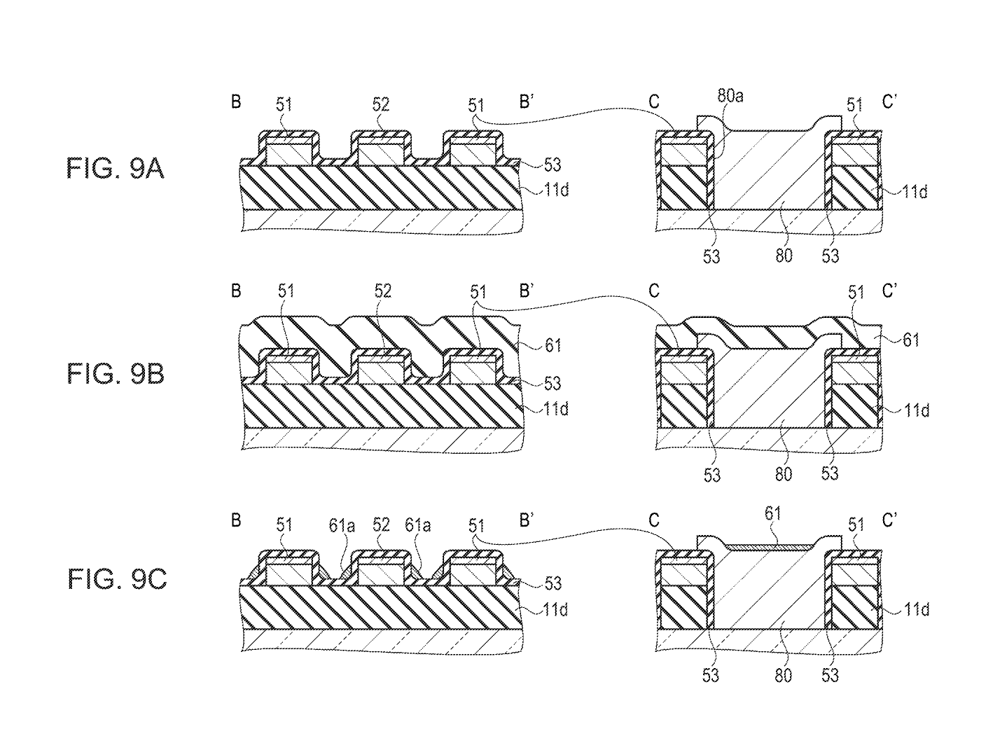

In a process shown in FIG. 9A, the color filter 80 is formed. First, the concave portion 80a is filled with a coloring material. As a filling method, a spin coating method, an ink-jet method, and the like can be used. Then, the color filter 80 is cured by heating the coloring material to be completed.

In a process shown in FIG. 9B, the first oxide film 61 are formed on the first wiring 51, the second wiring 52, the protective film 53, and the color filter 80. The first oxide film 61 is an oxide film (SiO₂) which has Tetra Ethyl Ortho Silicate (TEOS) formed by using, for example, a Low Pressure Chemical Vapor Deposition (LPCVD) device, as a raw material.

In a process shown in FIG. 9C, the side wall 61a is formed at a side surface of the second wiring 52 through the protective film 53. Specifically, for example, the side wall 61a is formed by performing an etching back process on the first oxide film 61. Accordingly, the side walls 61a which have an inclined surface are formed on side surfaces of the second wiring 52, and thereby it is possible to moderate an undulation between adjacent second wirings 52.

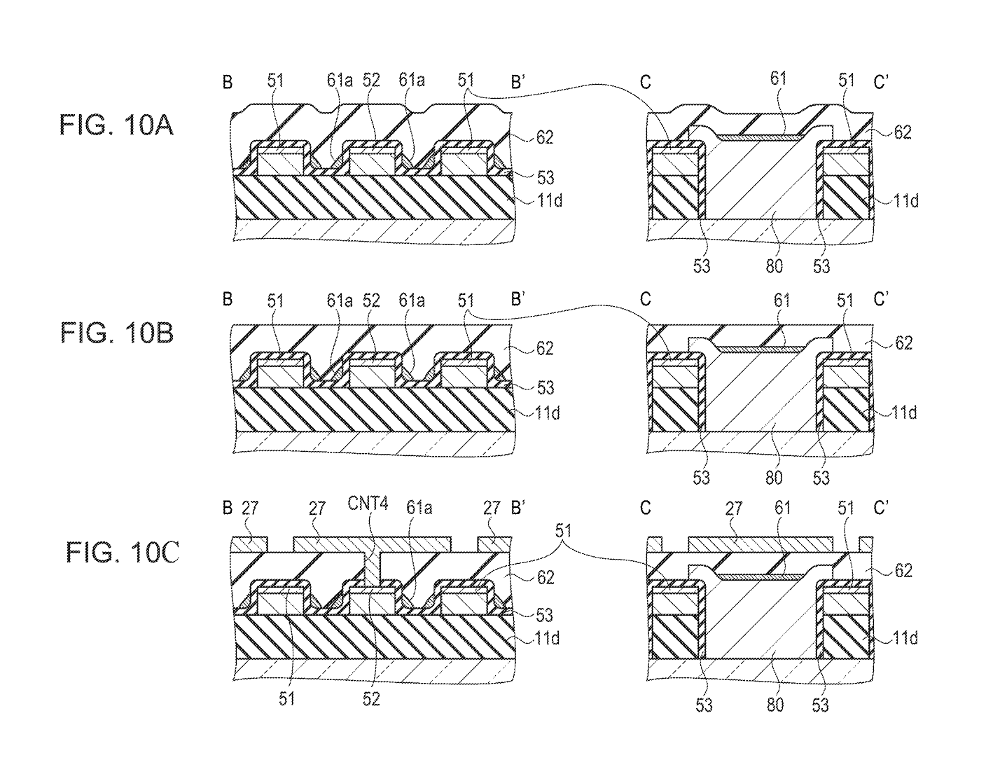

In a process shown in FIG. 10A, the second oxide film 62 is formed on the first wiring 51, the second wiring 52, the side wall 61a, the protective film 53, and the color filter 80. The second oxide film 62 is an oxide film (SiO₂), which has TEOS as a raw material, by using a LPCVD device in the same manner as the first oxide film 61. Since the side walls 61a are formed on side surfaces of the second wiring 52, it is possible to suppress a void so as not to occur in a gap between adjacent second wirings 52.

In a process shown in FIG. 10B, a surface of the second oxide film 62 is planarized. As a planarizing method, for example, CMP polishing is exemplified. Accordingly, it is possible to form an oxide film without a void between the second wirings 52.

In a process shown in FIG. 10C, the pixel electrode 27 is formed. Specifically, first, a contact hole CNT4 is formed in a region overlapping a portion of the second wiring 52 in a plan view in the second oxide film 62. Then, on the planarized second oxide film 62, an ITO film is formed. Next, the pixel electrode 27 is formed in a region overlapping the color filter 80 and the second wiring 52 in a plan view by patterning the ITO film.

The contact hole CNT4 is filled with the ITO film, and thereby the pixel electrode 27 and the source/drain region at a pixel electrode side 30d are electrically connected to each other through the second wiring 52 (relay electrode).

In step S18, the alignment film 28 is formed on the pixel electrode 27 and the second oxide film 62. As a method of manufacturing the alignment film 28, an oblique deposition method of obliquely depositing inorganic materials such as silicon oxide (SiO₂) and the like are used. Thus, the element substrate 10 side is completed.

Next, a method of manufacturing the opposite substrate 20 side will be described. First, in step S21, the opposite electrode 31 is formed on the base material 20a which is made of light-permeable materials such as a glass substrate and the like by using the well-known deposition technique such as the photolithography technique and the etching technique. Specifically, the opposite electrode 31 can be formed by sputtering and etching a transparent conductive film such as the ITO and the like.

In step S22, the alignment film 32 is formed on the opposite electrode 31. A method of manufacturing the alignment film 32 forms the alignment film 32 by using, for example, the oblique deposition method in the same manner as when forming the alignment film 28. Accordingly, the opposite substrate 20 side is completed. Next, a method of bonding the element substrate 10 and the opposite substrate 20 will be described.

In step S31, the sealing material 14 is applied onto the element substrate 10. In detail, by changing a relative positional relationship between the element substrate 10 and a dispenser (possibly a discharge device), the sealing material 14 is applied to the periphery of the display region E (so as to surround the display region E) in the element substrate 10.

As the sealing material 14, for example, a UV-curable epoxy region is exemplified. The sealing material 14 is not limited to a light-curable resin such as UV rays, and may be made to use a thermosetting resin and the like. In addition, the sealing material 14 includes, for example, a glass fiber or gap materials such as glass beads and the like for setting a gap between the element substrate 10 and the opposite substrate 20 (gap or cell gap) to a predetermined value.

In step S32, the element substrate 10 and the opposite substrate 20 are bonded together. Specifically, in the element substrate 10, the element substrate 10 and the opposite substrate e20 are bonded through the applied sealing material 14.

In step S33, a liquid crystal is injected from a liquid crystal inlet into the inside of a structure, and then the liquid crystal inlet is sealed with a sealing material. Sealing materials such as a resin and the like are used in the sealing. Accordingly, the liquid crystal device 100 is completed.

### Configuration of Electronic Apparatus

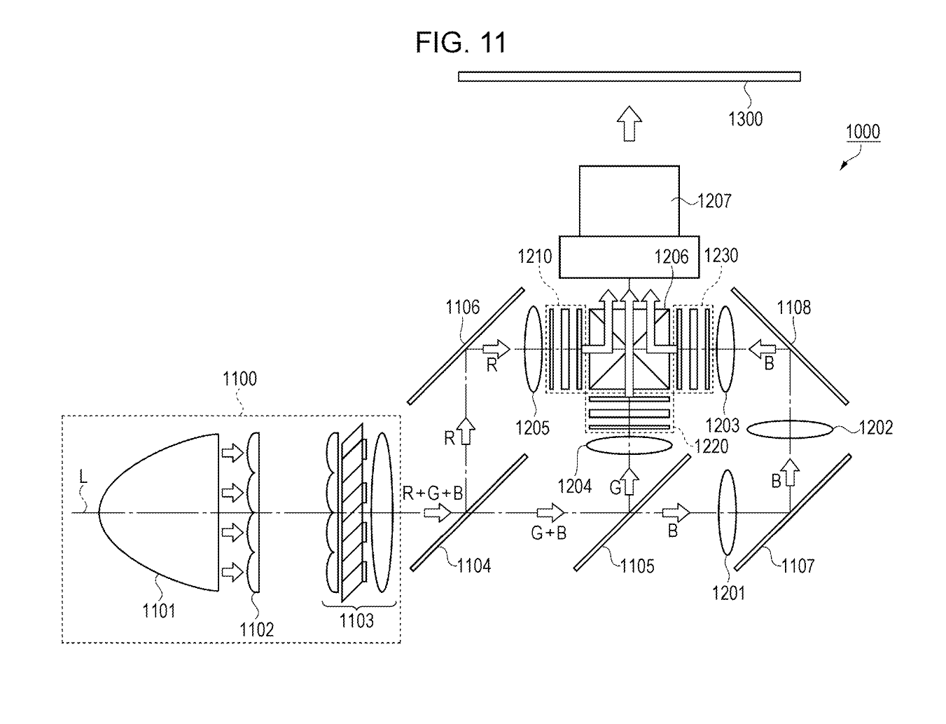

Next, a projection type display device as an electronic apparatus of the embodiment will be described referring to FIG. 11. FIG. 11 is a schematic diagram which shows a configuration of the projection type display device including the liquid crystal device described above.

As shown in FIG. 11, a projection type display device 1000 of the embodiment includes a polarization illumination device 1100 disposed along a system optical axis L, two dichroic mirrors 1104 and 1105 as a light separation element, three reflection mirrors 1106, 1107, and 1108, five relay lenses 1201, 1202, 1203, 1204, and 1205, three permeable liquid crystal light valves 1210, 1220, and 1230 as optical modulation means, a cross dichroic prism 1206 as a light synthesizing element, and a projection lens 1207.

The polarization illumination device 1100 is schematically configured to have a lamp-unit 1101 as a light source made of a white light source such as a ultrahigh-pressure mercury lamp, a halogen lamp, or the like, an integrator lens 1102, and a polarization conversion element 1103.

Among polarized light beams emitted from the polarization illumination device 1100, the dichroic mirror 1104 reflects red light (R) and allows green light (G) and blue light (B) to pass through the dichroic mirror 1104. The other dichroic mirror 1105 reflects the green light (G) passing through the dichroic mirror 1104 to allow the blue light (B) to pass through the dichroic mirror 1105.

The red light (R) reflected by the dichroic mirror 1104 is reflected by the reflection mirror 1106, and is incident on the liquid crystal light valve 1210 via the relay lens 1205. The green light (G) reflected by the dichroic mirror 1105 is incident on the liquid crystal light valve 1220 via the relay lens 1204. The blue light (B) passing through the dichroic mirror 1105 is incident on the liquid crystal light valve 1230 via a light guide system which is made of three relay lenses 1201, 1202, and 1203 and two reflection mirrors 1107 and 1108.

The liquid crystal light valves 1210, 1220, and 1230 are respectively disposed to face an incident surface per color light of the cross dichroic prism 1206. Color light incident on the liquid crystal light valves 1210, 1220, and 1230 is emitted toward the cross dichroic prism 1206 modulated based on image information (image signal).

The prism is made by bonding four right angle prisms, and a dielectric multilayer film for reflecting the red light and a dielectric multilayer film for reflecting the blue light are formed in a cross shape at an inner surface of the prism. Three color lights are synthesized by these dielectric multilayer films, and light for displaying a color image is synthesized. The synthesized light is projected to a screen 1300 by a projection lens 1207 which is a projection optical system, and the image is enlarged and displayed.

The liquid crystal device 100 described above is applied to the liquid crystal light valve 1210. The liquid crystal device 100 is disposed at a gap between a pair of polarized elements disposed in a cross Nicol state in an incident side and an emission side of color light. The other liquid crystal light valves 1220 and 1230 are the same as the liquid crystal light valve 1210.

According to such a projection type display device 1000, using the liquid crystal light valves 1210, 1220, and 1230 makes it possible to obtain high reliability.

As an electronic apparatus mounted with the liquid crystal device 100, in addition to the projection type display device 1000, various types of electronic apparatus such as an Electrical View Finder (EVF), a mobile mini projector, a head-up display, a smart phone, a mobile phone, a mobile computer, a digital camera, a digital video camera, a display, an automotive apparatus, an audio apparatus, an exposure apparatus, or a lighting apparatus can be used.

As described above, according to the element substrate 10, the method of manufacturing the element substrate 10, and the liquid crystal device 100, and the electronic apparatus of the embodiment, effects shown in the followings will be obtained.

(1) According to the element substrate 10, the method of manufacturing the element substrate 10, and the liquid crystal device 100 of the embodiment, since the first wirings 51 having a light shielding property are provided so as to interpose the color filter 80, for example, it is possible to prevent light passing through a pixel P from being incident on the color filter 80 of a neighboring pixel P. Accordingly, it is possible to prevent color mixture or light leakage, and to improve a display quality. In addition, since the protective film 53 is provided between the first wiring 51 and the color filter 80, it is possible to prevent the first wiring 51 from being corroded by contact between the first wiring 51 and the color filter 80.

(2) According to the element substrate 10, the method of manufacturing the element substrate 10, and the liquid crystal device 100 of the embodiment, since the first wiring 51 is in a floating state, for example, even if the protective film 53 is not reliably formed in the first wiring 51, it is possible to suppress a metallic material included in the color filter 80 so as not to affect a function of the first wiring 51 as a wiring.

(3) According to the electronic apparatus of the embodiment, since the electronic apparatus of the embodiment includes the liquid crystal device 100 described above, it is possible to provide an electronic apparatus which can improve a display quality.

Aspects of the present invention are not limited to the embodiments described above, can be appropriately changed within a scope not contrary to a gist or a concept of the invention which can be read from the claims and an entire specification, and are included in a technical scope of embodiments of the invention. The embodiments can be also performed in a following form.

### MODIFICATION EXAMPLE 1

As described above, it is not limited that the protective film 53 is provided to cover the first wiring 51, the second wiring 52, the concave portion 80a, and the third interlayer insulation layer 11d, but may also be provided only between the first wiring 51 and the color filter 80 so that at least the first wiring 51 (particularly, the aluminum 50a) and the color filter 80 do not come into contact with each other. Accordingly, it is possible to prevent the aluminum 50a from being corroded by contact between the first wiring 51 and the color filter 80.

### MODIFICATION EXAMPLE 2

As described above, it is not limited that the first wiring 51 is set to a light-shielding film and the second wiring 52 is set to a relay electrode, and the other wirings or electrodes having a concave and convex portion may be assumed to be the first wiring 51 and the second wiring 52. For example, wirings near a driver disposed in a vicinity of the display region E may be assumed to be the first wiring 51 and the second wiring 52.

### MODIFICATION EXAMPLE 3

As described above, the side wall 61a formed on side surfaces of the first wiring 51 and the second wiring 52 is not limited to being formed using the etching back method, but may be formed using the other manufacturing methods.

### MODIFICATION EXAMPLE 4

As described above, end portions of adjacent color filters 80 are not limited to being disposed so as to open a gap above the first wiring 51, but the end portions of adjacent color filters 80 may also be disposed so as to be adjacent to each other, that is, to straddle each other. Accordingly, display unevenness can be suppressed.

### MODIFICATION EXAMPLE 5

As described above, as an electro-optical device, not only the liquid crystal device 100 but also, for example, an organic El device, a plasma display, an electronic paper and the like are used.

The entire disclosure of Japanese Patent Application No. 2013-190201, filed Sep. 13, 2013 is expressly incorporated by reference herein.

What is claimed is:

1. A substrate for an electro-optical device comprising:
a base;
a first insulation layer provided above the base, the first insulation layer has a concave portion;
a plurality of first wirings provided above the first insulation layer so as to interpose the concave portion;
a protective film provided so as to cover the plurality of the first wirings;
a color filter provided in the concave portion;
a second insulation layer provided above the color filter and the plurality of first wirings; and
a pixel electrode provided above the second insulation layer.

2. The substrate for an electro-optical device according to claim 1,
wherein each of the plurality of first wirings is not electrically connected to wirings.

3. The substrate for an electro-optical device according to claim 1,
wherein the protective film is provided over an inner surface of the concave portion from one of the plurality of the first wirings.

4. An electro-optical device comprising:
the substrate for an electro-optical device according to claim 1;
an opposite substrate disposed to face the substrate for an electro-optical device; and
an electro-optical layer disposed between the substrate for an electro-optical device and the opposite substrate.
